(19) United States
(12) Patent Application Publication
(10) Pub. No.: US 2025/0068149 A1
(43) Pub. Date: Feb. 27, 2025

(54) DATA PROCESSING METHOD AND DATA PROCESSING DEVICE

(71) Applicants: Inventec (Pudong) Technology Corp., Shanghai (CN); Inventec Corporation, Taipei (TW)

(72) Inventors: Wei-Chao Chen, Taipei (TW); Ming-Chi Chang, Taipei (TW); Ghih-Pin Wei, Taipei (TW); Jing-Lun Huang, Taipei (TW); Siang-Yu Lan, Taipei (TW); Shu-Huei Yang, Taipei (TW)

(73) Assignees: Inventec (Pudong) Technology Corp., Shanghai (CN); Inventec Corporation, Taipei (TW)

(21) Appl. No.: 18/389,802

(22) Filed: Dec. 20, 2023

(30) Foreign Application Priority Data
Aug. 25, 2023 (CN) 202311086765.7

(51) Int. Cl. G05B 19/418

(52) U.S. Cl. CPC G05B 19/41875; G05B 2219/32368

(57) ABSTRACT

A data processing method applied in a data center is provided. The data processing method includes obtaining stored procedures of a development environment, a data quality assurance system environment and a production environment from the data center, generating table lineage graphs of the development environment, the data quality assurance system environment and the production environment respectively according to the stored procedures of the development environment, the data quality assurance system environment and the production environment, wherein the step including parsing each stored procedure to determine a directed graph of each stored procedure for each environment and merging the directed graphs of all stored procedures in each environment to generate a table lineage graph for each environment, comparing the table lineage graphs of the development environment, the data quality assurance system environment and the production environment to generate a comparison result, and performing a notification function according to the comparison result.

### BACKGROUND OF THE INVENTION

### 1. Field of the Invention

The present invention relates to a data processing method and a data processing device, and more particularly, to a data processing method and a data processing device capable of real-time comparison of differences of table 1 relationships for different environments.

### 2. Description of the Prior Art

A data center usually includes tables and stored procedures. The table may be used as a data carrier, which provides the capability to store data. The stored procedures are responsible for the conversion and correlation logic between tables and data. When a software engineer or developer of the data center modifies the logical relationship between the tables and data, the stored procedures need to be modified accordingly. Due to the large number of stored procedures in the data center and the stored procedures are logically related to each other, when the software engineer of the data center adds or modifies the stored procedure, it may cause changes in the data center that affect the table lineage relationship between tables of the data center. Conventional verification method is to conduct sampling verification on the data before modifying the stored procedure and the data after modifying the stored procedure. However, this verification method is not only time-consuming, but also cannot prove e the correctness. Moreover, in many cases, conventional method often relies on data users to find abnormality and feed error information back to the software engineer in the data center. However, wrong data may cause potential and invaluable losses to the company. As such, modifying the stored procedures is a very dangerous job for the software engineer of the data center. Further, with more and more stored procedures, the risk of modification may increase and also affect the speed of digital transformation for the company. Thus, there is a need for improvement.

### SUMMARY OF THE INVENTION

It is therefore a primary objective of the present invention to provide a data processing method and a data processing device capable of real-time comparison of differences of table lineage relationships for different environments, in order to resolve the aforementioned problems.

The present invention discloses a data processing method, applied in a data center, comprising: obtaining stored procedures of a development environment, a data quality assurance system environment and a production environment from the data center; generating table lineage graphs of the development environment, the data quality assurance system environment and the production environment respectively according to the stored procedures of the development environment, the data quality assurance system environment and the production environment, wherein the step comprises: parsing each stored procedure to determine a directed graph of the stored procedure for each environment of the development environment, the data quality assurance system environment and the production environment; and merging directed graphs of all stored procedures in each environment to generate a table lineage graph for each environment, wherein the step comprises when determining that a source table of a first stored procedure and a target table of a second stored procedure are the same table, merging a first node representing the source table of the first stored procedure and a second node representing the target table of the second stored procedure; comparing the table lineage graphs of the development environment, the data quality assurance system environment and the production environment to generate a comparison result; and performing a notification function according to the comparison result.

The present invention further discloses a data processing device, applied in a data center, comprising: a storage device, configured to store instructions; a processor circuit, configured to execute the instructions of: obtaining stored procedures of a development environment, a data quality assurance system environment and a production environment from the data center; generating table lineage graphs of the development environment, the data quality assurance system environment and the production environment respectively according to the stored procedures of the development environment, the data quality assurance system environment and the production environment, wherein the step comprises: parsing each stored procedure to determine a directed graph of the stored procedure for each environment of the development environment, the data quality assurance system environment and the production environment; and merging directed graphs of all stored procedures in each environment to generate a table lineage graph for each environment, wherein the step comprises when determining that a source table of a first stored procedure and a target table of a second stored procedure are the same table, merging a first node representing the source table of the first stored procedure and a second node representing the target table of the second stored procedure; comparing the table lineage graphs of the development environment, the data quality assurance system environment and the production environment to generate a comparison result; and performing a notification function according to the comparison result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flow diagram of a procedure according to an embodiment of the present invention.

FIG. 2 is a schematic diagram illustrating directed graphs of the stored procedures according to an embodiment of the present invention.

FIG. 3 is a schematic diagram illustrating the source directed subgraph of the table lineage graph according to an embodiment of the present invention.

FIG. 4 is a schematic diagram illustrating the target directed subgraph of the table lineage graph according to an embodiment of the present invention.

FIG. 5 is a schematic diagram illustrating comparison of the table lineage graphs of the development environment and the data quality assurance system environment according to an embodiment of the present invention.

FIG. 6 is a schematic diagram illustrating comparison of the table lineage graphs of the data quality assurance system environment and the production environment according to an embodiment of the present invention.

### DETAILED DESCRIPTION

The embodiments of the present invention may be applied to a data center or a database system. In order to prevent errors caused by addition and modification of stored procedures, the embodiments of the present invention may establish a development environment, a data quality assurance (QAS) system environment and a production environment in the data center. The development environment may be utilized to add and modify the stored procedures, and ensure that the amended stored procedures are able to be executed normally and there is no coding error in the programs of the stored procedures. In the development environment, developers or software engineers may load original data and stored procedures, and modify the stored procedures according to requirements. After the stored procedures are amended, the updated version data and stored procedures of the development environment may be copied to the data quality assurance system environment. The data quality assurance system environment may provide data users to identify whether the data changes after adding or modifying stored procedures meet the requirements. In the data quality assurance system environment, data users may utilize various test methods to test, so as to determine whether the data changes meet the requirements. As data users perform testing and find any flaw or defect in the data quality assurance system environment, the problems found in the data quality assurance system environment may be solved by the developer or software engineer in the development environment, and the processed (the latest updated version) data and stored procedures of the development environment may be copied to the data quality assurance system environment. Similarly, the data users may perform related testing again in the data quality assurance system environment until the expected result is available or no problem has occurred. The production environment is the actual operational data center environment where the application is finally deployed and made available to data users. Therefore, when the data quality assurance system environment completes the data user testing task and verifies that the data changes meet the requirements, the developer or software engineer of the data center may update the production environment to the latest newly version of the modified stored procedures.

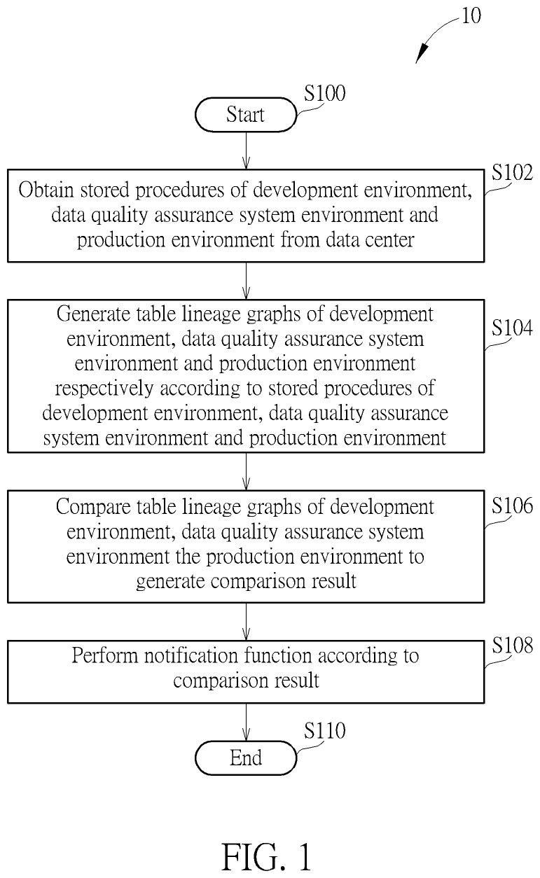

Please refer to FIG. 1. FIG. 1 is a flow diagram of a procedure 10 according to an embodiment of the present invention. The procedure 10 includes the following steps:

Step S100: Start.

Step S102: Obtain stored procedures of a development environment, a data quality assurance system environment and a production environment from the data center.

Step S104: Generate table lineage graphs of the development environment, the data quality assurance system environment and the production environment respectively according to the stored procedures of the development environment, the data quality assurance system environment and the production environment.

Step S106: Compare the table lineage graphs of the development environment, the data quality assurance system environment and the production environment to generate a comparison result.

Step S108: Perform a notification function according to the comparison result.

Step S110: End.

According to the procedure 10, in Step S102, the embodiments of the present invention may obtain stored procedures of the development environment, the data quality assurance system environment and the production environment from the data center. Next, in Step S104, the table lineage graphs of the development environment, the data quality assurance system environment and the production environment respectively may be generated according to the stored procedures of the development environment, the data quality assurance system environment and the production environment. In an embodiment, the table lineage graph of the development environment may be generated according to the stored procedures of the development environment. Each stored procedure of the development environment may be parsed to determine a directed graph of the stored procedure. For example, a stored procedure parser engine may be utilized to parse the stored procedure and accordingly generate a directed graph of the stored procedure. For example, a SQL parser engine of software Python may be utilized to parse the stored procedure and generate a corresponding directed graph of the stored procedure. Each stored procedure may include at least one source table and at least one target table (also called destination table). Each stored procedure may merely include at least one source table. Each stored procedure may merely include at least one target table. The directed graph of the stored procedure may include nodes representing source tables and/or target tables. The directed graph of the stored procedure may include directed edges representing the stored procedures. The direction of the directed edge is from a source table of the stored procedure to a target table of the stored procedure. Each stored procedure may correspond to at least one directed graph.

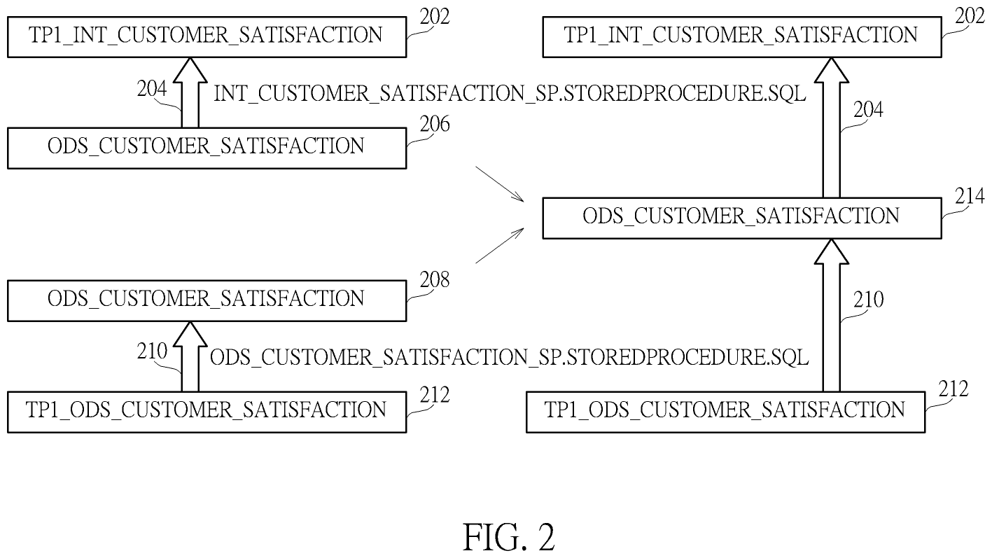

For example, please refer to FIG. 2, as shown in the upper left side of FIG. 2, a first stored procedure is named “INT_CUSTOMER_SATISFACTION_SP.STOREDPROCEDURE.SQL”. A directed graph of the first stored procedure includes nodes 202 and 206, and a directed edge 204. The node 202 represents a target table of the first stored procedure. The target table of the first stored procedure is named “TP1_INT_CUSTOMER_SATISFACTION”. The node 206 represents a source table of the first stored procedure. The source table of the first stored procedure is named “ODS_CUSTOMER_SATISFACTION”. The directed edge 204 represents the first stored procedure, and the direction of the directed edge 204 is from the node 206 of the source table to the node 202 of the target table. Please further refer to FIG. 2. As shown in the bottom left side of FIG. 2, a second stored procedure is named “ODS_CUSTOMER_SATISFACTION_SP.STOREDPROCEDURE.SQL”. A directed graph of the second stored procedure includes nodes 208 and 212, and a directed edge 210. The node 208 represents a target table of the second stored procedure. The target table of the second stored procedure is named “ODS_CUSTOMER_SATISFACTION”. The node 212 represents a source table of the second stored procedure. The source table of second the procedure stored is named “TP1_ODS_CUSTOMER_SATISFACTION”. The directed edge 210 represents the second stored procedure, and the direction of the directed edge 210 is from the node 212 of the source table to the node 208 of the target table.

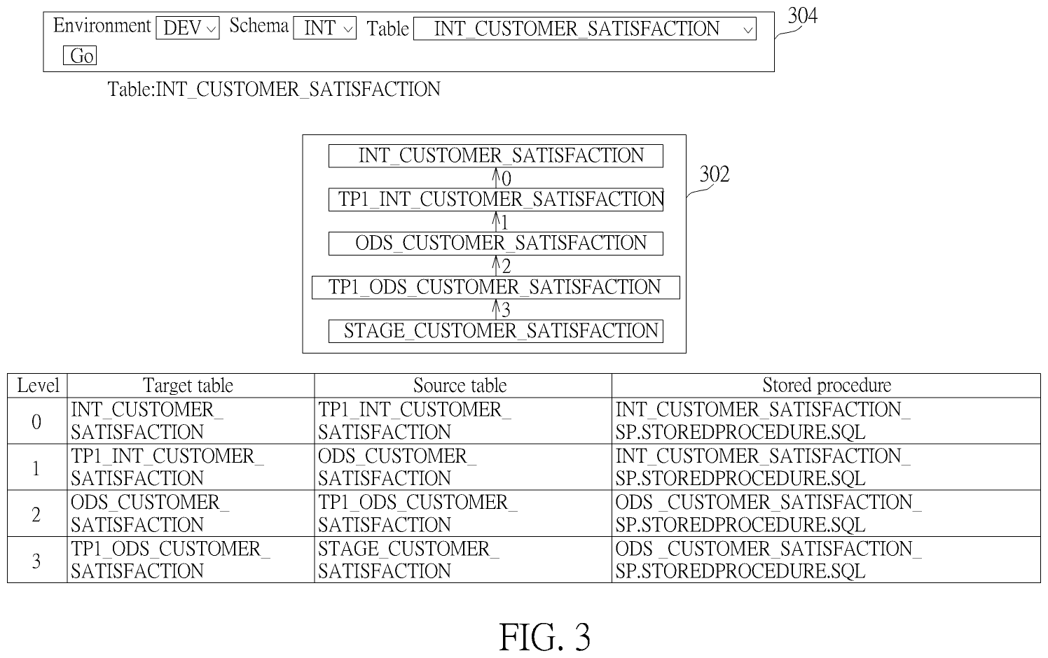

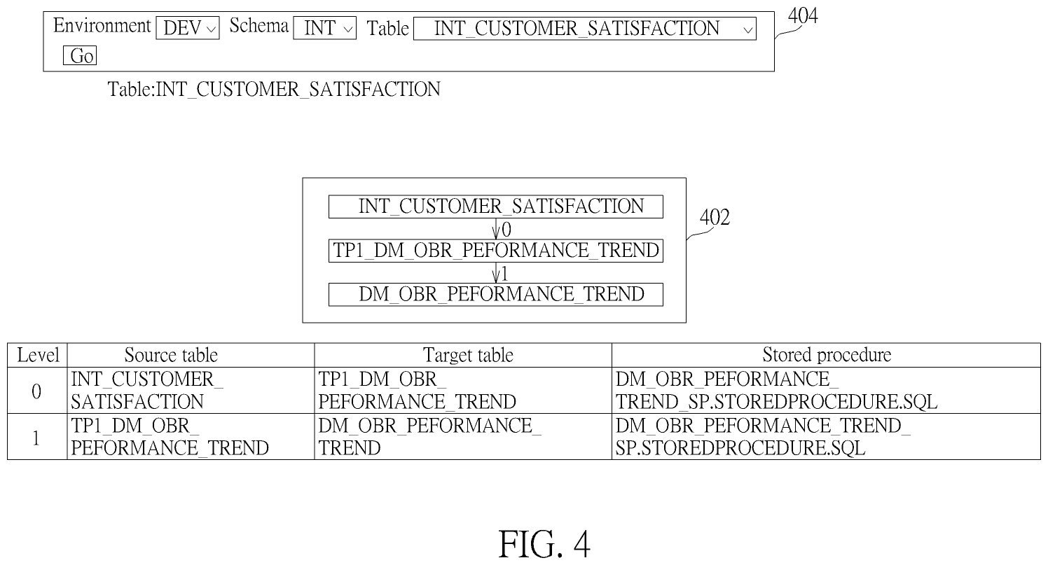

In Step S104, the table lineage graph of the development environment may be generated by merging the directed graphs of all stored procedures in the development environment after the table lineage graphs of the development environment has been parsed. The table lineage graph may represent the relationship between tables. For example, the embodiments may compare the directed graphs of all stored procedures in the development environment. For example, when determining that a source table of a stored procedure in the development environment and a target table of other stored procedure in the development environment are the same table, a node representing the source table of the stored procedure and a node representing the target table of other stored procedure may be merged to form a corresponding table lineage graph. For example, as shown in the left side of FIG. 2, when determining that the source table of the first stored procedure and the target table of the second stored procedure are the same table (i.e. table “ODS_CUSTOMER_SATISFACTION” of nodes 206 and 208), the nodes 206 and 208 may be merged to form a new node 214, so as to combine the two directed graphs to form a part of the table lineage graph. In such a situation, the node 214 is utilized to represent the source table of the first stored procedure and the target table of the second stored procedure, and thus the directed graph of the first stored procedure and the directed graph of the second stored procedure are connected and merged accordingly. Through the merging method, the directed graphs of all stored procedure in the development environment may be merged and converted into the table lineage graph of the development environment. The table lineage graph may include at least one source directed subgraph and/or at least one target directed subgraph. The source directed subgraph may be a directed subgraph ending in a specific table. The target directed subgraph may be a directed subgraph starting from a specific table. In an embodiment, please refer to FIG. 3. FIG. 3 is a schematic diagram of a source directed subgraph in the table lineage graph according to the embodiment of the present invention. The middle of FIG. 3 shows a source directed subgraph 302 corresponding to the table named “INT_CUSTOMER_SATISFACTION”. In the source directed subgraph 302, a node representing the table “INT_CUSTOMER_SATISFACTION” is the ending point. The source directed subgraph 302 includes parent nodes associated with the table “INT_CUSTOMER_SATISFACTION”. In an embodiment, please refer to FIG. 4. FIG. 4 is a schematic diagram” of a target directed subgraph in the table lineage graph according to the embodiment of the present invention. The middle of FIG. 4 shows a target directed subgraph 402 corresponding to table named “INT_CUSTOMER_SATISFACTION”. In the target directed subgraph 402, a node representing the table “INT_CUSTOMER_SATISFACTION” is the starting point. The target directed subgraph 402 includes child nodes associated with the table “INT_CUSTOMER_SATISFACTION”.

Similarly, according to the aforementioned method of generating the table lineage graph of the development environment, the table lineage graph of the data quality assurance system environment may be generated according to the stored procedures of the data quality assurance system environment. The directed graph of each stored procedure may be determined by parsing each stored procedure of the data quality assurance system environment, and the directed graphs of all stored procedures in the data quality assurance system environment may be merged to generate the table lineage graph of the data quality assurance system environment after parsing the directed graphs of all stored procedures of the data quality assurance system environment. Similarly, the table lineage graph of the production environment may be generated according to the stored procedures of the production environment. The directed graph of each stored procedure may be determined by parsing each stored procedure of the production environment, and the directed graphs of all stored procedures in the production environment may be merged to generate the table lineage graph of the production environment after parsing the directed graphs of all stored procedures of the production environment.

In an embodiment, after generating the table lineage graphs of the development environment, the data quality assurance system environment and the production environment, an input menu may be generated for the user to input and select. For example, please further refer to FIG. 3 and FIG. 4. input menus 304 and 404 may be generated. The user may utilize the input menu to select the desired environment types, table types (or called schemas), table names, and so on. For example, the user may click the item “DEV” in the field (or called column) of the environment type to select the development environment, click the item “INT” in the field of table type to select the INT table, and click the item “INT_CUSTOMER_SATISFACTION” in the field of named table name to select the table “INT_CUSTOMER_SATISFACTION”. In an embodiment, the input menu may be visually displayed for the user to view and input the item to be selected, and the related information of the selected table lineage graph may be visually displayed. As shown in FIG. 3 and FIG. 4, the embodiment may visualize the input menu for the user to view and input the desired item, and visualize the contents of the directed subgraphs of the selected table, the corresponding stored procedures, the source tables and the target tables. Therefore, the user, e.g., administrator or engineer of the data center, may quickly and accurately get the relationship information of data structure of stored procedures in the corresponding environment.

In Step S106, the embodiments may compare the table lineage graphs of the development environment, the data quality assurance system environment and the production environment to generate a comparison result. For example, the embodiments may compare the table lineage graphs of at least two environments among the development environment, the data quality assurance system environment and the production environment to generate the comparison result. For example, the embodiments may compare the table lineage graph of the development environment with the table lineage graph of the data quality assurance system environment to generate the comparison result. For example, the embodiments may compare the table lineage graph of the data quality assurance system environment with the table lineage graph of the production environment to generate the comparison result. For example, the embodiments may compare the table lineage graph of the development environment with the table lineage graph of the production environment to generate the comparison result. In addition, the embodiments may also select specific tables to compare to generate the comparison results. For example, the embodiments may compare source directed subgraphs or target directed subgraphs corresponding to at least one table in the table lineage graphs of at least two environments among the development environment, the data quality assurance system environment and the production environment to generate the comparison result. The table schemas may include DM table, INT table, ODS table, STAGE table. A table whose name is prefixed with DM is called a DM table (e.g., a table named “DM XXXX”). A table whose name is prefixed with INT is called an INT table, and the like. The DM table is usually located at the end of the table lineage graph. Since the DM table is usually the endpoint table in the table lineage graph, if there is a difference or any inconsistency between the two environments, the difference may be quickly and easily detected by comparison. In an embodiment, the embodiments may compare the source directed subgraph corresponding to a DM table of the table lineage graph of any two environments in the development environment, the data quality assurance system environment and the production environment to generate the comparison result.

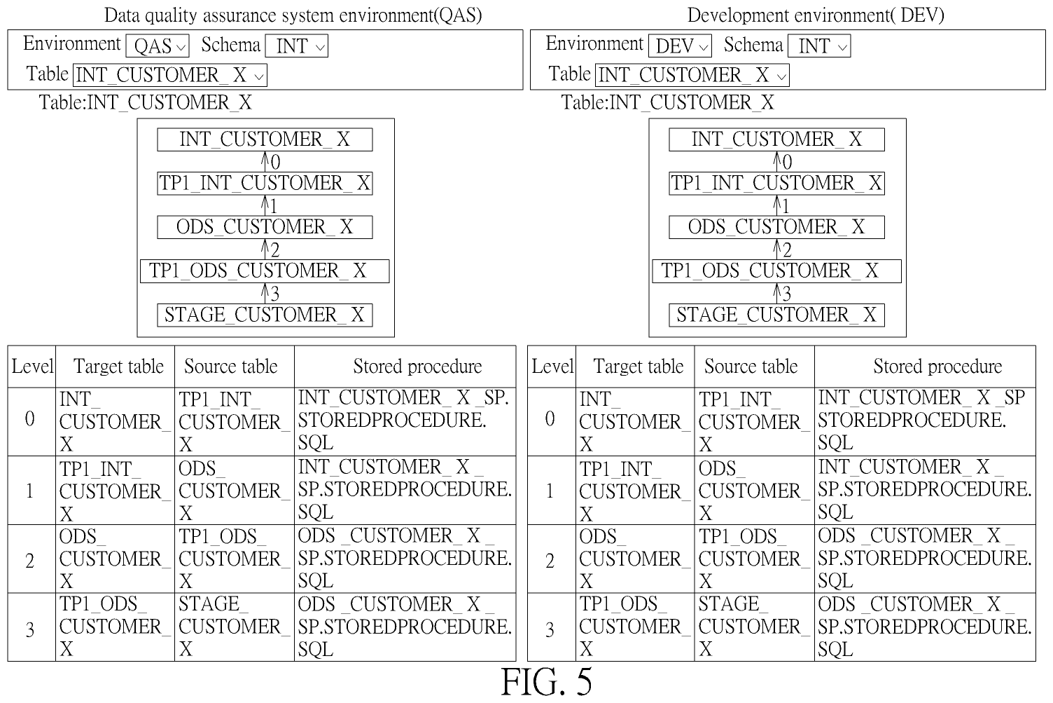

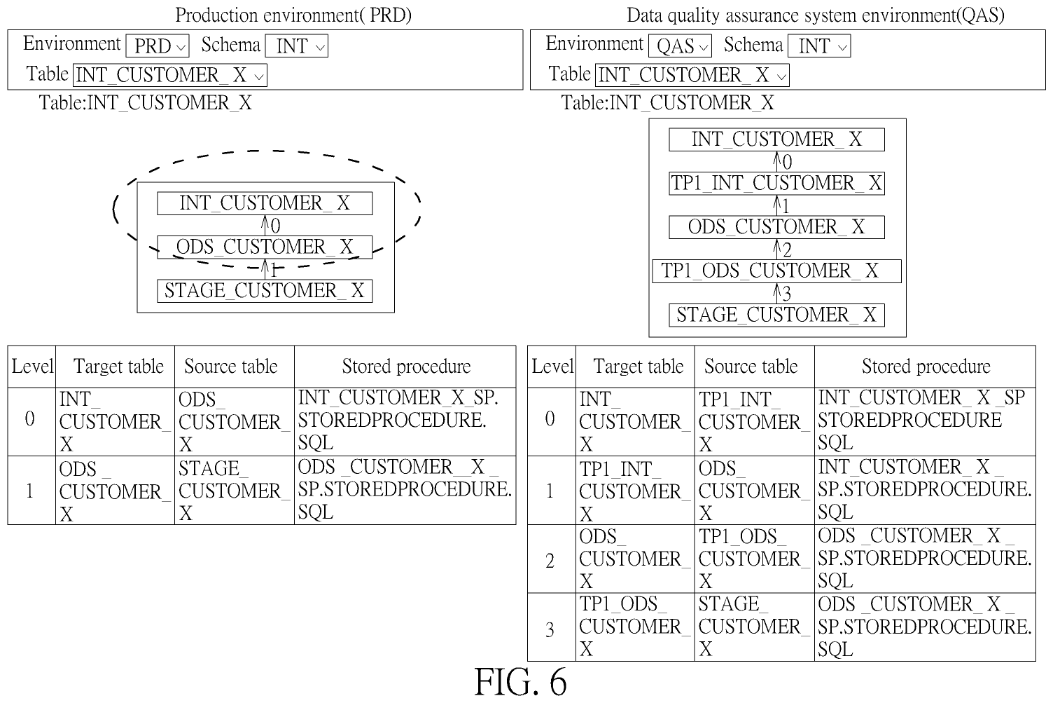

In Step S108, the embodiments may perform a notification function according to the comparison result generated in Step S106. When the comparison result indicates that there is a difference between the table lineage graphs of two of the development environment, the data quality assurance system environment and the production environment, the embodiments may generate and send a notification signal to inform the administrator or engineer of the data center about the difference of the table lineage graph, so as to execute the notification function. For example, FIG. 5 shows source directed subgraphs corresponding to a table named “INT_CUSTOMER_X of the development environment and the data quality assurance system environment, respectively. FIG. 6 shows source directed subgraphs corresponding to a table named “INT_CUSTOMER_X of and the data quality assurance system environment and the production environment, respectively. As shown in FIG. 5 and FIG. 6, the table “INT_CUSTOMER_X” is the end point of the source directed subgraph in the development environment, the data quality assurance system environment and the production environment. After comparing the table lineage graphs of the development environment, the data quality assurance system environment and the production environment, the comparison results indicates that the data quality assurance system environment and the development environment have the same source directed subgraph, and the source directed subgraph of the production environment is different from the source directed subgraphs of the development environment and the data quality assurance system environment. As shown in FIG. 5, the software engineer selects the development environment and the data quality assurance system environment for comparison in Step S106. The comparison results indicates that the source directed subgraph corresponding to the table “INT_CUSTOMER_X” of the data quality assurance system environment is the same as the source directed subgraph corresponding to the table “INT_CUSTOMER_X” of the development environment. As shown in FIG. 6, the software engineer selects the data quality assurance system environment and the production environment for comparison in Step S106. The comparison results indicates that the source directed subgraph corresponding to the table “INT_CUSTOMER_X” of the production environment is different from the source directed subgraph corresponding to the table “INT_CUSTOMER_X” of the data quality assurance system environment. As shown in FIG. 6, the source tables corresponding to the stored procedure “INT_CUSTOMER_X_SP.STOREDPROCEDURE.SQL” at level 0 are different. In the production environment, the source table corresponding to the stored procedure “INT_CUSTOMER_X_SP.STOREDPROCEDURE.SQL” at level 0 is the table “ODS_CUSTOMER_X”. In the data quality assurance system environment, the tables to the source corresponding stored procedure “INT_CUSTOMER_X_SP.STOREDPROCEDURE.SQL” at level 0 is the table “TP1_INT_CUSTOMER_X”. This means that the stored procedure update operation of the production environment may be wrong or abnormal, or have not yet been executed. As such, the comparison result indicates that a difference exists between the source directed subgraphs of the table lineage graph of the data quality assurance system environment the production environment. Since the comparison results indicates that a difference exists between the source directed subgraphs of the table lineage graph of the data quality assurance system environment and the production environment, a notification signal may be generated and sent to notify the administrator or software engineer of the data center about the difference between the data quality assurance system environment and the production environment, so as to perform the notification function. In this way, the administrator or software engineer of the data center may easily and immediately determine whether there is an error situation occurred according to the notification signal.

Therefore, during the development phase of application service, when adding or modifying the stored procedures in the development environment, the software engineer may compare the table lineage graph of the development environment with the table lineage graph of the data quality assurance system environment to determine whether or not there is a difference between the development environment and the data quality assurance system environment, so as to ensure the correctness and accuracy of whole system after adding or modifying the stored procedures and also greatly improve the timeliness and efficiency of application service development. During the development phase of application service, as the amended stored procedures are updated and deployed into the production environment, the software engineer may compare the table lineage graph of the production environment with the table lineage graph of the data quality assurance system environment to determine whether or not there is a difference between the production environment and the data quality assurance system environment, to identify whether the stored procedure update process of the production environment is executed correctly and successfully. Accordingly, when an error occurs in the stored procedure update process of the production environment, the embodiments may quickly find out the stored procedure to be affected. In an embodiment, a monitoring period may be set (e.g., the monitoring period may be every day, every week or every specific period), such that the data center may execute the steps of the procedure 10 every monitoring period to compare the table lineage graphs of the development environment, the data quality assurance system environment and the production environment and send the comparison results back to the data center, thus providing an automatic test and notification mechanism for the software engineers of the data center, avoiding manual input errors and realizing automatic testing. Meanwhile, the automatic testing would also significantly improve the efficiency of the production testing process.

Those skilled in the art should readily make combinations, modifications and/or alterations on the abovementioned description and examples. The abovementioned description, steps, procedures and/or processes including suggested steps can be realized by means that could be hardware, software, firmware (known as a combination of a hardware device and computer instructions and data that reside as read-only software on the hardware device), an electronic system or combination thereof. Examples of hardware can include analog, digital and/or mixed circuits known as microcircuit, microchip, or silicon chip. For example, the hardware may include application-specific integrated circuit (ASIC), field programmable gate array (FPGA), programmable logic device, coupled hardware components or combination thereof. In another example, the hardware may include general-purpose processor, microprocessor, controller, digital signal processor (DSP) or combination thereof. Examples of the software may include set(s) of codes, set(s) of instructions and/or set(s) of functions retained (e.g., stored) in a storage device, e.g., a non-transitory computer-readable medium. The non-transitory computer-readable storage medium may include read-only memory (ROM), flash memory, random access memory (RAM), subscriber identity module (SIM), hard disk, floppy diskette, or CD-ROM/DVD-ROM/BD-ROM, but not limited thereto. The embodiments of the invention may include a data processing device, and the data processing device may include a processing circuit and a storage device. Any of the abovementioned procedures and examples above may be compiled into program codes or instructions that are stored in the storage device or a computer-readable medium. The processing circuit may read and execute the program codes or the instructions stored in the storage device storage device or computer-readable medium for realizing the abovementioned functions.

To sum up, the data processing method of the embodiments of the present invention may obtain the table lineage graphs of each environment. When the software engineer develops the application service for the data center, the difference of the table lineage graphs in various environments may be obtained real time by comparison, thereby effectively improving the correctness and timeliness of the system while modifying the stored procedures, identifying whether the stored procedure update process of the production environment is executed correctly, and greatly improving and optimizing the speed of digital transformation for company.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data processing method, applied in a data center, comprising:
obtaining stored procedures of a development environment, a data quality assurance system environment and a production environment from the data center;
generating table lineage graphs of the development environment, the data quality assurance system environment and the production environment respectively according to the stored procedures of the development environment, the data quality assurance system environment and the production environment, wherein the step comprises:
parsing each stored procedure to determine a directed graph of the stored procedure for each environment of the development environment, the data quality assurance system environment and the production environment; and
merging directed graphs of all stored procedures in each environment to generate a table lineage graph for each environment, wherein the step comprises when determining that a source table of a first stored procedure and a target table of a second stored procedure are the same table, merging a first node representing the source table of the first stored procedure and a second node representing the target table of the second stored procedure;
comparing the table lineage graphs of the development environment, the data quality assurance system environment and the production environment to generate a comparison result; and
performing a notification function according to the comparison result.

2. The data processing method of claim 1, wherein the step of comparing the table lineage graphs of the development environment, the data quality assurance system environment and the production environment to generate the comparison result comprises:
comparing the table lineage graphs of at least two environments among the development environment, the data quality assurance system environment and the production environment to generate the comparison result.

3. The data processing method of claim 1, wherein the step of comparing the table lineage graphs of the development environment, the data quality assurance system environment and the production environment to generate the comparison result comprises:
comparing source directed subgraphs or target directed subgraphs corresponding to at least one table in the table lineage graphs of at least two environments among the development environment, the data quality assurance system environment and the production environment to generate the comparison result.

4. The data processing method of claim 1, wherein the step of performing the notification function according to the comparison result comprises:
when the comparison result indicates that there is a difference between the table lineage graphs of two of the development environment, the data quality assurance system environment and the production environment, generating and sending a notification signal to execute the notification function.

5. The data processing method of claim 1, further comprising:
generating an input menu for input selection, and visualizing the input menu and related information of table lineage graphs selected via the input menu.

6. A data processing device, applied in a data center, comprising:
a storage device, configured to store instructions;
a processor circuit, configured to execute the instructions of:
obtaining stored procedures of a development environment, a data quality assurance system environment and a production environment from the data center;
generating table lineage graphs of the development environment, the data quality assurance system environment and the production environment respectively according to the stored procedures of the development environment, the data quality assurance system environment and the production environment, wherein the step comprises:
parsing each stored procedure to determine a directed graph of the stored procedure for each environment of the development environment, the data quality assurance system environment and the production environment; and
merging directed graphs of all stored procedures in each environment to generate a table lineage graph for each environment, wherein the step comprises when determining that a source table of a first stored procedure and a target table of a second stored procedure are the same table, merging a first node representing the source table of the first stored procedure and a second node representing the target table of the second stored procedure;
comparing the table lineage graphs of the development environment, the data quality assurance system environment and the production environment to generate a comparison result; and
performing a notification function according to the comparison result.

7. The data processing device of claim 6, wherein the instructions further comprise:
comparing the table lineage graphs of at least two environments among the development environment, the data quality assurance system environment and the production environment to generate the comparison result.

8. The data processing device of claim 6, wherein the instructions further comprise:
comparing source directed subgraphs or target directed subgraphs corresponding to at least one table in the table lineage graphs of at least two environments among the development environment, the data quality assurance system environment and the production environment to generate the comparison result.

9. The data processing device of claim 6, wherein the instructions further comprise:
when the comparison result indicates that there is a difference between the table lineage graphs of two of the development environment, the data quality assurance system environment and the production environment, generating and sending a notification signal to execute the notification function.

10. The data processing device of claim 6, wherein the instructions further comprise:
generating an input menu for input selection, and visualizing the input menu and related information of table lineage graphs selected via the input menu.
